(19) United States
(12) Patent Application Publication
(10) Pub. No.: US 2005/0260105 A1
(43) Pub. Date: Nov. 24, 2005

(54) Incense burner

(76) Inventor: Xin-Long Xu, Pan-Chiao City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/847,581

(22) Filed: May 18, 2004

(51) Int. Cl. A62B 7/08

(52) U.S. Cl. 422/126

(57) ABSTRACT

An incense burner consists of a base holder, a container, a cap and powder press-molding apparatus. Particularly, the incense burner is designed to allow ashes of powdered incense to be formed into the form of petals, naturally relying on the circulation of incense smoke and air drafts inside the incense burner after the ignited powdered incense is fully consumed.

### BACKGROUND OF THE INVENTION

1. Field of the Invention

The present invention relates to an incense burner and more particularly to a new incense burner for allowing ashes of powdered incense to be formed into the petal naturally after the ignited powdered incense placed within a container of the incense burner is fully consumed, which is by means of the circulation of air drafts inside the incense burner and the arrangement of vents on the cap of the incense burner.

2. Prior Art

In the present society, people being in modern times have busy life as the standard of living is better and religious belief has been a primary way for people to repose their spirits on; thus burning incense sticks has also been an initial approach for the believer to practice Buddhist or Taoist rules. However, typical prior art incense burners are consisting of a base member, a container and a cap. A stick of incense is lit within the container and then incense smoke and air drafts can be dissipated through vents on the surface of the cap. After the ignited stick of incense is fully consumed, only piles of black ashes without having special forms are leaving in the container.

### OBJECTS OF THE INVENTION

The inventor of the present invention is a pious Buddhist believer having practiced Buddhist rules for several years. In order to solve the above problem, he provides a well-designed incense burner comprising a base holder, a container, a cap and a powder press-molding apparatus. Fill the powder press-molding apparatus with powdered incense to mold into a coned column of powdered incense and place said coned column of powdered incense within the container. After igniting the coned column of powdered incense, the arrangement of vents on the surface of the cap permits incense smoke and air drafts to be dissipated through said vents. Some of incense smoke and air drafts without being dissipated will flow circularly inside the incense burner to press the coned column of powdered incense so that ashes of said powdered incense is formed into shapes of petals of a flower, naturally as it is fully consumed.

### BRIEF DESCRIPTION OF DRAWINGS

Further objects, structures and functions of the present invention will become apparent upon consideration of the following detailed description in conjunction with the drawings of the embodiment.

FIG. 1 is a perspective view of the present invention.

FIG. 2 is a perspective view of the present invention taken apart.

FIG. 3 is a top cross-sectional view of the present invention.

FIG. 4 is a perspective view of the power press-molding apparatus of the present invention.

FIG. 5 is is an illustration of the direction of incense smoke and air drafts during the operation of the present invention.

FIG. 6 is a perspective view of ashes as the ignited powdered incense is fully consumed.

### DESCRIPTION OF THE REFERRED EMBODIMENT

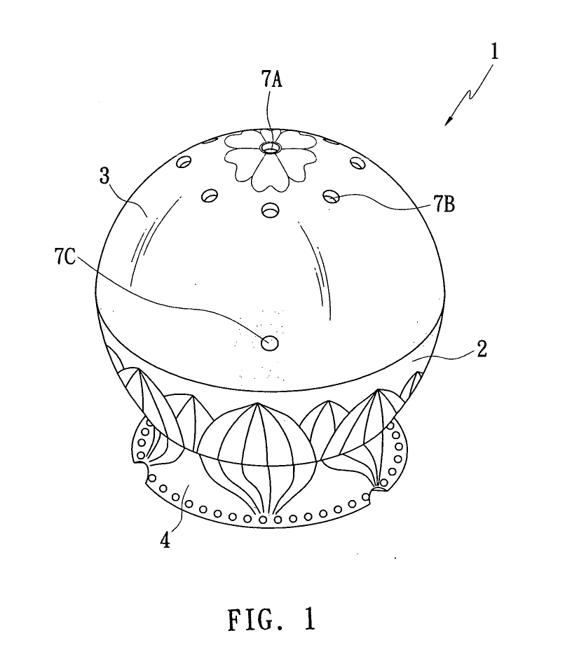

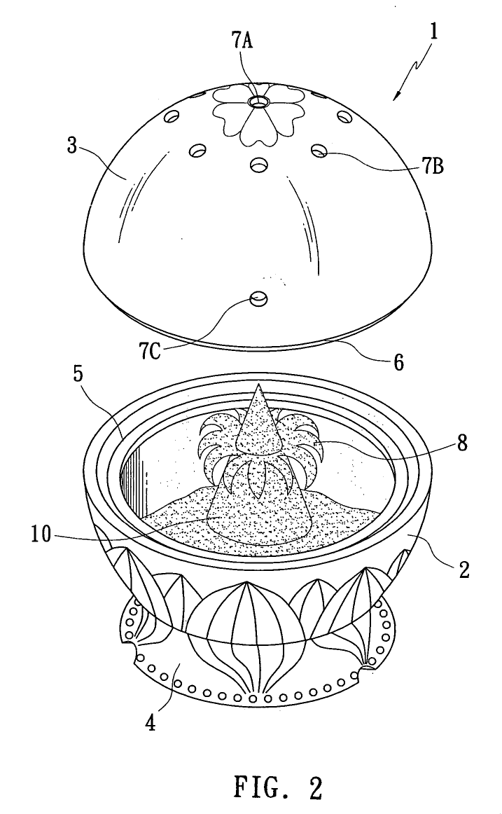

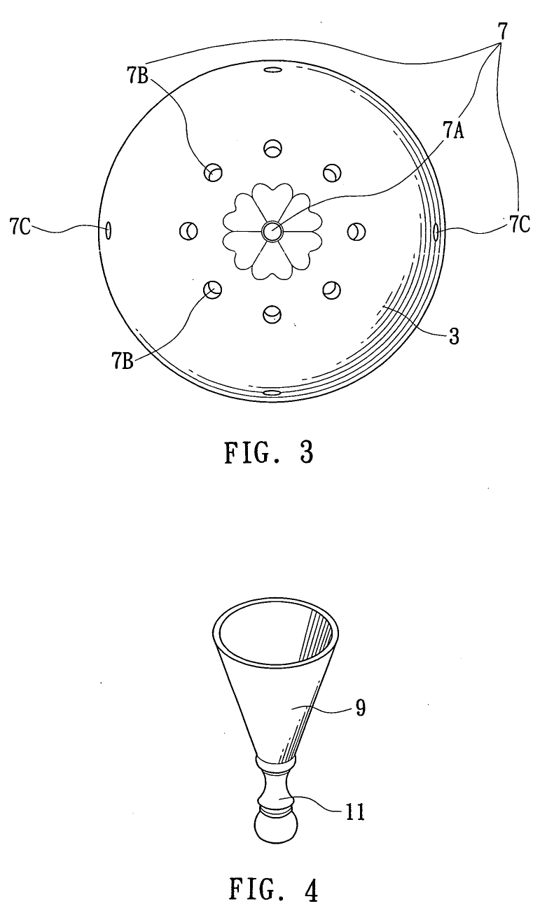

As illustrated in FIG. 1 through 3, an incense burner 1 comprises a container 2, a cap 3, a base holder 4 and a powder press-molding apparatus 9. The container 2 is a hollow body in the form of an arc. The external surface of the container 2 can be decorated with patterns for making the incense burner 1 pleasant to look at. The base holder 4 and the bottom edge of said container 2 are constructed to merge together for allowing the incense burner 1 to be positioned stably. A bearing ring 5 is set on the interior side of the top edge of the container 2 for bearing a flange 6 on the interior side of the bottom edge of the cap 3 so that the cap 3 can cover the container 2 properly. The cap 3 is a hollow domed body and several vents 7 are arranged on the surface of said cap 3. In a preferred embodiment of the incense burner 1 in accordance with the present invention, it is designed to arrange four vents 7C on the surface adjacent to the bottom edge of the cap 3 and each of them is apart at an angle of 90 degrees. A vent 7A is positioned proximate a center of the top of the cap 3; also, eight vents 7B are arranged annular in a suitable place along the bottom edge of said vent 7A and each of them is apart at an angle of 45 degrees. By the design of vents 7 on the cap 3 herein, incense smoke and air drafts inside the incense burner 1 allow ashes 8 of powdered incense 10 to be formed into the twelve-petaled flower as powdered incense 10 is fully consumed.

Turning now to the accompanying FIG. 4 through 6, in the embodiment of the present invention, powdered incense is made of Chinese medicine, such as herbs. Said herbs in themselves have fiber with viscidity so that fill the powder press-molding apparatus 9 with said powdered incense 10 to mold into a coned column of powdered incense 10. And then turn over the powder press-molding apparatus 9 to place said coned column of powdered incense 10 within the container 2. The powder press-molding apparatus 9 is a hollow cone body provided to be filled with powdered incense 10 so that powdered incense 10 can be molded into a coned column of powdered incense 10, whose size is in accordance with the container 2 and the cap 3 of the incense burner 1. A handle 11 is on the pointed end of said powdered press-molding apparatus 9 merging together to make the powder press-molding apparatus 9 easily accessible for holding. As igniting the coned column of powdered incense 10 within the container 2, some of incense smoke and air drafts are dissipated through vents 7A, 7B, 7C but others flow upwards to the top of the cap 3 and then downwards along the internal wall of the cap 3 to produce circulating air which presses the outer layer of the coned column of powdered incense 10. For that reason, ashes 8 of powdered incense 10 are formed into flower petal shapes, naturally.

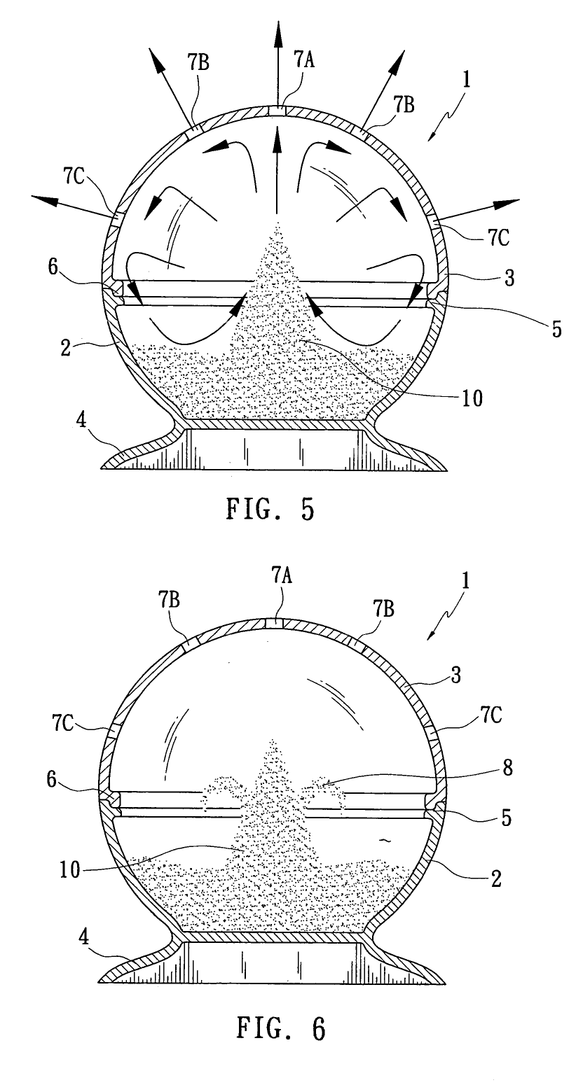

Referring to FIG. 5 and FIG. 6, during the operation of the above system, besides some incense smoke being influenced by surrounding air, other smoke and air drafts flow upwards after powdered incense 10 has been lit. The principle of the present invention relying on the circulation of air drafts is using the arrangement of vents 7 to influence directions of incense smoke and air drafts so as to reach the effect of forming ashes 8 of powdered incense 10 into the flower petal shapes.

1. An incense burning system, comprising:
a container defined by a hollow body having an arcuate contour, said container having a bearing ring on an interior side of a top edge thereof;
an incense composition formed into a column and disposed in said container;
a base holder, said base holder being coupled to a lower edge of said container;
a cap defined by a hollow domed body with a plurality of vents formed through a surface thereof and a flange formed on an interior side of a bottom edge of said cap, said cap overlaying said container with said flange being contiguous to said bearing ring, said plurality of vents consisting of (a) a first vent being centrally located at a top of said cap, (b) a set of second vents being radially spaced from said first vent to be located adjacent said lower edge of said cap, said set of second vents being spaced apart each from the other by ninety degrees, and (c) a set of third vents being annularly disposed and radially spaced from said first vent to be between said first and second vents, said third vents being spaced apart each from the other by forty-five degrees, wherein said plurality of vents provide an airflow pattern within said container covered by said cap to form ash from consumption of said incense composition into a plurality of flower petal-shaped protuberances extending from said column; and
a powder press-molding apparatus, said powder press-molding apparatus having a hollow body with a cone-shaped contour for molding said incense composition into a conically shaped column, said powder press-molding apparatus having a handle extending from an apex of said cone-shaped hollow body.
